(19) United States
(12) Patent Application Publication
(10) Pub. No.: US 2004/0054716 A1
(43) Pub. Date: Mar. 18, 2004

(54) Method, computer product and computer system to manage software-tool access over a network

(75) Inventors: Trung M. Tran, Round Rock, TX (US); Alan C. Folta, Austin, TX (US)

Correspondence Address: ZAGORIN O'BRIEN & GRAHAM, L.L.P., 7600B N. CAPITAL OF TEXAS HWY., SUITE 350, AUSTIN, TX, 78731, US

(73) Assignee: SUN MICROSYSTEMS, INC., Palo Alto, CA

(21) Appl. No.: 10/244,974

(22) Filed: Sep. 17, 2002

(51) Int. Cl. G06F 15/16; G06F 17/50

(52) U.S. Cl. 709/203; 716/1

(57) ABSTRACT

Provided are a method, a computer product and a computer system to manage software-tool access over a network. The network is employed to develop multiple integrated circuit designs, each of which is considered a project. To that end, multiple software design tools are accessed over the network. To reduce the computational power required to manage access to the design tools, the present method associates the multiple projects with a reference file. Tool information, such as tool name and tool version, is associated with each of the multiple projects. The tool information for all of the projects is stored in one or more tool files. The reference file is provided with data indicating a location of the tool files, defining location data. As a result, project information may be obtained as a function of the tool name, the project name and the like.

### BACKGROUND OF THE INVENTION

The present invention relates to integrated circuit development, and more specifically to development of integrated circuits over a computer network

Computer networks facilitate collaborative efforts of several individuals remotely disposed from one another. Typically, a computer network includes a plurality of users employing client computers communicating with one or more remote server computers to transfer data therebetween and allow access to one or more software programs. The remote server computers may store various integrated circuit designs in a process, referred to as projects. In addition, the remote servers may store the tools necessary to design and test the integrated circuit designs associated with the projects. An exemplary suite of software tools is DESIGN FRAMEWORK II® tool suite from CADENCE®.

To facilitate data transfer between the server and the client computers, employed is one or more of several protocols, such as the standardized Hypertext Transfer Protocol (HTTP) for wide area networking environments or the Ethernet protocol for communicating over local area networking environments. Communication between the server and the client terminal is achieved through software executed on the client terminal that creates an interface. Most commonly the interface is graphics driven, thereby providing the user with a graphical user interface (GUI)-based communication with data obtained from a server.

The GUI displays information that includes selectable elements, such as file selection links and virtual buttons, on a display device for a user to view and select. When a selectable element is selected the underlying computer based application responds by providing information and performing certain operations. As a result the GUI is employed to obtain project files from the remote servers, as well as the appropriate tools.

Managing the access to the aforementioned files over the network has presented a challenge. Specifically, it is desired to provide quick access to the desired project files and requisite tools associated with the project files, while minimizing the computation requirements to that end. Achieving these seemingly contradictory requirements is exacerbated as the number of the numbers of projects and tools increase. Access management is further hindered when multiple versions of the tools are included in the network. Specifically, each project is associated with a particular version of each of the design tools used to develop the integrated circuit associated therewith.

One manner in which to manage the access to the projects and tools is to provide, for each project, a particular file that includes the address of the project and the tool version associated with the project. However, as the number of projects increases, the quantity of data to manage the access increases two-fold. This can increase the computational power required to manage access to the design tools and projects of the network.

A need exists, therefore, to improve management access of design tools and project information over a network.

### SUMMARY OF THE INVENTION

The present invention provides a method and computer product to manage software-tool access over a network. The network is employed to develop multiple integrated circuits designs, each of which is considered a project. To that end, multiple software design tools are accessed over the network. Typically, different versions of one or more of the design tools are accessible over the network, with each project being associated with a particular version of the design tools. To reduce the computational power required to manage access to the design tools the present method associates the multiple projects with a common file, defining a reference file. Tool information, such as tool name and tool version is associated with each of the multiple projects. The tool information for all of the projects is stored in a common tool file. The common reference file is provided with data indicating a location of the common tool file, defining location data. As a result, project information may be obtained as a function of the tool name, the project name and the like. Specifically, a search routine may be executed, in response to receipt of tool information, which calls reference file to locate the common tool file on the network. The common tool file is then parsed to extract the projects associated with the tool name, as well as the tool version.

### BRIEF DESCRIPTION OF THE DRAWINGS

FIG. 1 is a simplified plan view of a computer network in which the present invention is implemented;

FIG. 2 is a block diagram of a client terminal shown in FIG. 1;

FIG. 3 is a flow diagram of a method to manage access to software design tools in accordance with one embodiment of the present invention;

FIG. 4 is a flow diagram of a method to manage access to software design tools in accordance with a first alternate embodiment of the present invention;

FIG. 5 is a flow diagram of a method to manage access to software design tools in accordance with a second alternate embodiment of the present invention; and

FIG. 6 is a flow diagram of a method to manage access to software design tools in accordance with a third alternate embodiment of the present invention.

### DETAILED DESCRIPTION OF THE PREFERRED EMBODIMENTS

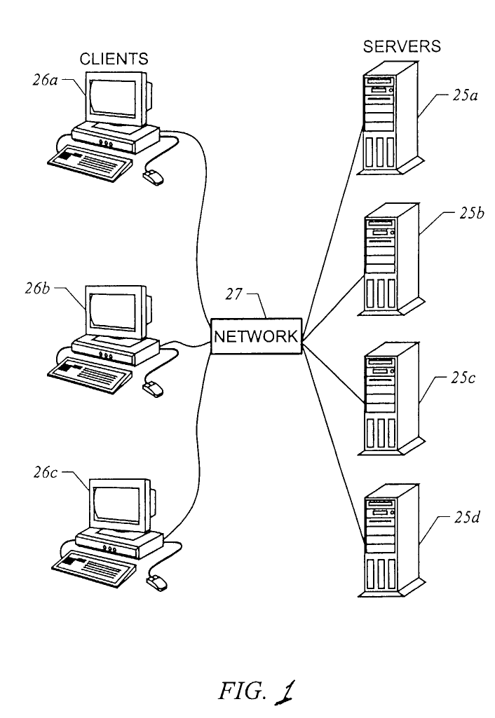

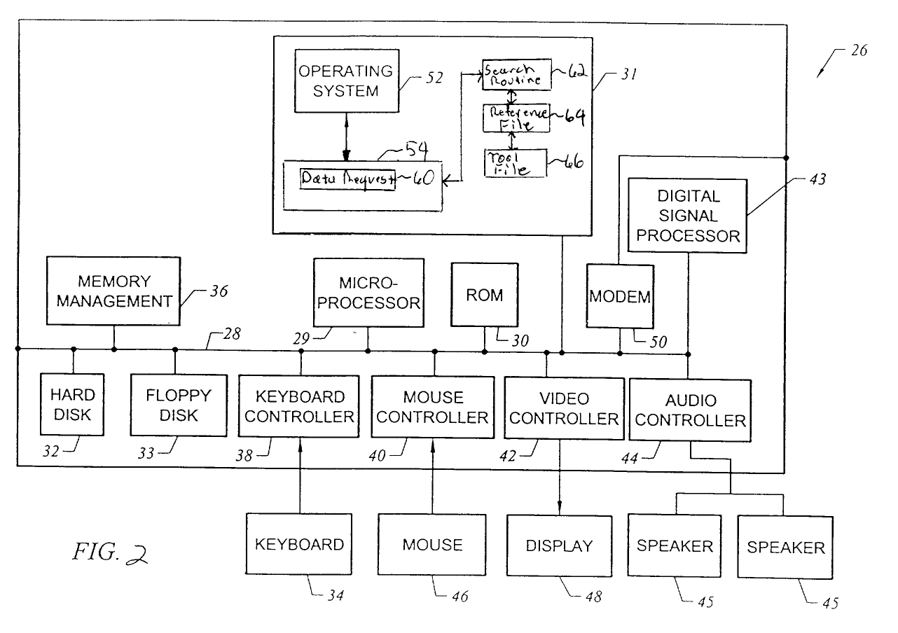

Referring to FIG. 1, shown is a plurality of servers 25a, 25b, 25c and 25d accessible by client terminals 26a, 26b and 26c over a network 27. Communication between servers 25a, 25b, 25c and 25d and client terminals 26a, 26b and 26c may be over a public network, such as a public switched telephone network, over ASDL telephone lines or large bandwidth trunks, such as Tl or OC3 service. Alternatively, client terminals 26a, 26b and 26c may communicate with servers 25a, 25b, 25c and 25d over a local area network. In the present example, the invention is discussed with respect to communication over a network employing Ethernet protocols. To facilitate communication over network 27, client terminals 26a, 26b and 26c execute application specific software, to produce a user interface, shown more clearly in FIG. 2.

Referring to FIGS. 1 and 2, each of the client terminals 26a, 26b and 26c includes one or more system buses 28 placing various components thereof in data communication. For example, a microprocessor 29 is placed in data communication with both a read only memory (ROM) 30 and random access memory (RAM) 31 via system bus 28. ROM 30 contains among other code, the Basic Input-Output System (BIOS) that controls basic hardware operation such as the interaction with peripheral components, e.g., disk drives 32 and 33, and keyboard 34.

RAM 31 is the main memory into which the operating system and application programs are loaded and affords at least 32 megabytes of memory space. A memory management chip 36 is in data communication with system bus 28 to control direct memory access (DMA) operations. DMA operations include passing data between the RAM 31 and the hard disk drive 32 and the floppy disk drive 33.

Also in data communication with system bus 28 are various I/O controllers: a keyboard controller 38, a mouse controller 40, a video controller 42, and an audio controller 44, which may be connected to one or more speakers 45. Keyboard controller 38 provides a hardware interface for keyboard 34, and mouse controller 40 provides a hardware interface for a mouse 46, or other point and click device. Video controller 42 provides a hardware interface for a display 48. A Network Interface Card (NIC) 50 enables data communication over the network facilitating data transmission speeds up to 1000 megabytes per second. The operating system 52 of the client terminal 26 may be UNIX, LINUX, DOS, WINDOWS-based or any known operating system.

User interface, which in the present example is a graphics driven interface referred to as a (GUI) 54, is loaded in RAM 31 to facilitate running application specific software stored on one of servers 25a, 25b, 25c or 25d. For example, GUI 54 may facilitate access to one or more software tools (not shown) employed to design integrated circuits (not shown) associated with one or more projects (not shown), such as a COMPOSER TOOL® available from CADENCE® and stored on one or more of servers 25a, 25b, 25c or 25d.

Access to the software tool by one or more of client terminals 26a, 26b and 26c requires data input into GUI 54 requesting certain files. The files requested contain information associated with a desired project, as well as, data concerning a tool employed to manipulate the information associated with the project, e.g., to further develop the integrated circuit associated with the project. To that end, a data request 60 is entered into GUI 54 which in turns calls a search routine 62. Search routine 62 calls a reference file 64 on one or more of servers that is then loaded into RAM 31. Reference file 64 includes location data (not shown). The location data (not shown) points to the location, on network 27, of a tool file 66. Tool file 66 includes information concerning the project and the tool version number of the tool associated with the project.

To reduce the computational power required to obtain information concerning the tool, tool version and project associated therewith, the present invention abrogates the need to create a reference file and a tool file for each project accessible over network 27. Rather, more than one project, e.g., multiple projects, is associated with a reference file. To that end, in accordance with one embodiment of the present invention multiple projects are associated with one or more reference files, one of which is shown as reference file 64. Reference file 64 points to the location to one or more tool files, shown as tool file 66, accessible over network 27. For purposes of the present description, reference file 64 points to the location of all tool files 66 accessible over network 27. Upon entering the requisite information into GUI 54, search routine 62 directs its query to the one or more reference files 64 accessible over network 27. The information employed to invoke search routine 62 may include any tool name, tool version information or project name associated with the one or more tool files 66. The benefit of associating more than one project with reference file 64 is that addresses for each tool file 66 associated with the projects may be included in fewer files, or a single file, as opposed to having a separate address file for each project. Thus, the amount of information that is accessed over network 27 in order to manage distribution of project, tool and tool version information is reduced.

In accordance with another embodiment of the present invention, the computational power required to obtain information concerning the tool, tool version and project associated therewith may include associating all tool information with a common tool file. As a result, the one or more reference files 64 need only to point to a single tool file 66, instead of multiple tool files 66. To that end, tool file 66 contains the tool name, tool version and project associated therewith for all projects and tools accessible over the network 27. This could result in substantially reducing the computational power required to manage access to projects and tool information over network 27. In addition, should further updates of the tools be included in network 27 and additional projects associated therewith, the time required to update this information would be substantially reduced. There would be fewer files that would be updated with this information, e.g., in the present example a single tool file 66 is all that would be updated. This also reduces the access requirement through network 27.

Referring to FIGS. 2 and 3, one embodiment of the present invention to manage software-tool access includes associating multiple projects with a common file, defining a reference file 64, at step 100. Reference file 64 includes data indicating a location of tool files 66. At step 102 tool information is associated with each of the multiple projects included in reference file 64. The tool information includes a tool name and a tool version and a project name. At step 104, the tool information for each of the multiple projects associated with reference file 64 is stored in one or more tool files 66. At step 106 project information is obtained from information associated with one of the multiple projects. The information may include the project name, the tool name or the tool version.

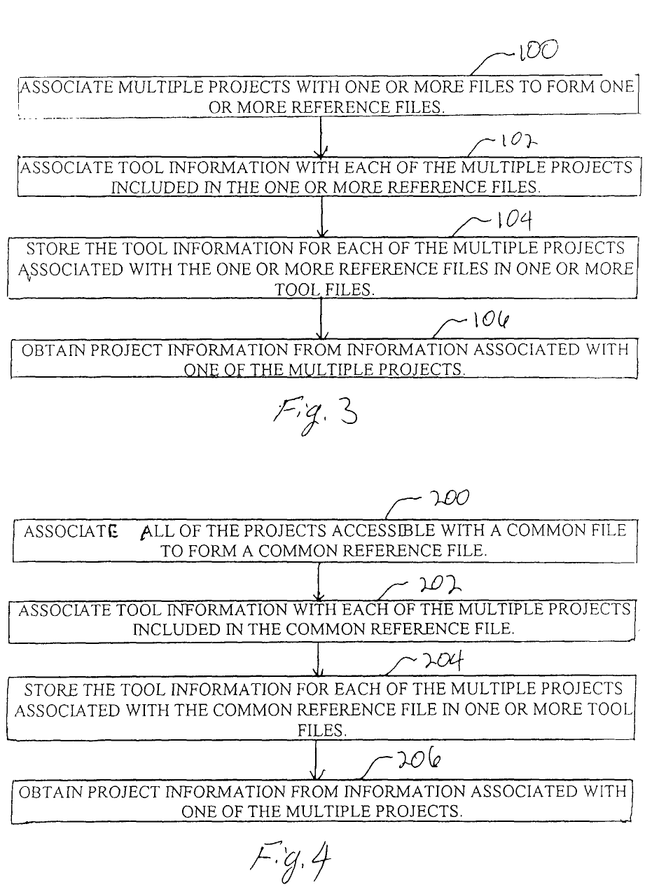

Referring to FIGS. 2 and 4, in accordance with another embodiment of the present invention, managing software-tool access includes associating all of the projects accessible over network 27 with a common file, defining a common reference file 64, at step 200. At step 202 tool information is associated with each of the multiple projects included in common reference file 64. At step 204, the tool information for each of the multiple projects associated with reference file 64 is stored in one or more tool files 66. At step 206 project information is obtained from information associated with one of the multiple projects. The information may include the project name, the tool name or the tool version.

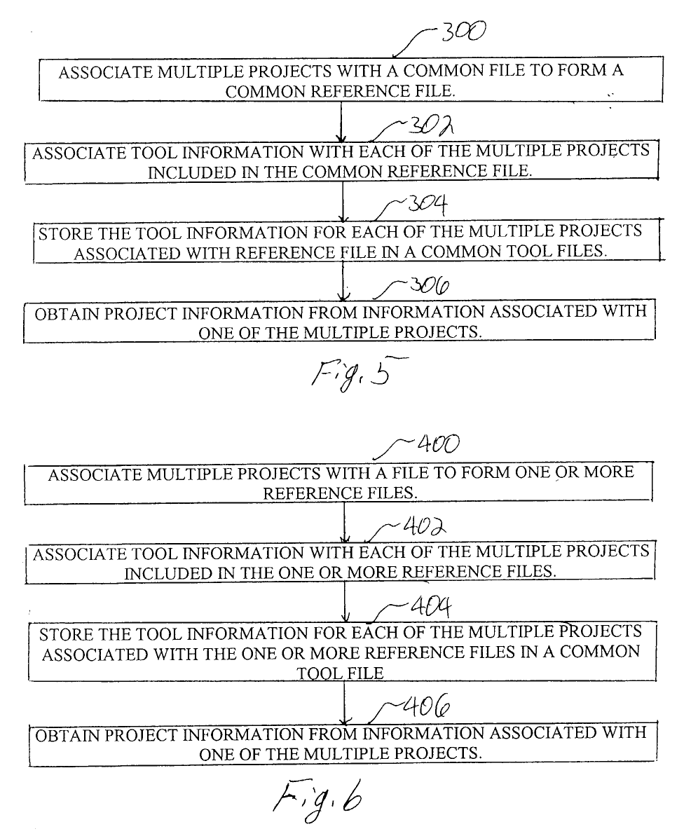

Referring to FIGS. 2 and 5, another embodiment of the present invention to manage software-tool access includes associating multiple projects with a common file, defining reference file 64, at step 300. At step 302 tool information is associated with each of the multiple projects included in reference file 64. At step 304, the tool information for each of the multiple projects associated with reference file 64 is stored in a common tool file 66. As a result, all tool information accessible over network 27 is located at a single address, the address where common tool file 66 resides. At step 306 project information is obtained from information associated with one of the multiple projects.

Referring to FIGS. 2 and 6, in accordance with yet another embodiment of the present invention, managing software-tool access includes associating all of the projects accessible over network 27 with a common file, defining reference file 64, at step 400. At step 402 tool information is associated with each of the multiple projects included in reference file 64. At step 404, the tool information for each of the multiple projects associated with reference file 64 is stored in a common tool file 66. At step 406 project information is obtained from information associated with one of the multiple projects. The information may include the project name, the tool name or the tool version. As a result, all tool information accessible over network 27 is located at a single address, the address where common tool file 66 resides. This embodiment minimized the amount of information required to reduce the computation requirements to manage software-tool access over network 27. This results from the search routine 62 having to seek only a single reference file 64 that includes a single address of a single tool file 66 in order to obtain information concerning the tool name and tool version associated with all projects accessible over network 27.

The embodiments of the present invention described above are exemplary. The scope of the invention should, therefore, be determined not with reference to the above description, but instead should be determined with reference to the appended claims along with their full scope of equivalents.

What is claimed is:

1. A method of managing software-tool access over a network, said method comprising:
associating multiple projects with a common file, defining a reference file;
associating tool information with each of said multiple projects, said tool information including a tool name and a tool version;
storing said tool information for each of said multiple projects in a file, defining a tool file;
providing said reference file with data indicating a location of said tool file, defining location data; and
obtaining project information from a set of data including a project name and a tool name, with said project information including a project name and a tool version associated with said project name.

2. The method as recited in claim 1 wherein obtaining further includes executing a search routine to parse information in said tool file to extract all projects associated with a common tool.

3. The method as recited in claim 1 wherein obtaining further includes executing a search routine that obtains said location data from said reference file and locates said tool file in response to said location data to parse said tool information associated with one of said multiple projects.

4. The method as recited in claim 1 wherein obtaining further includes executing a search routine that obtains said location data from said reference file and locates said tool file in response to said location data to parse said tool information associated with a group of said multiple projects.

5. The method as recited in claim 1 wherein obtaining further includes executing a search routine to parse information in said tool file to extract all project information associated with a common tool, with said project information including a project name and a version of said common tool associated with said project name.

6. The method as recited in claim 1 wherein said tools are integrated circuit design tools.

7. The method as recited in claim 1 wherein said tools are integrated circuit design tools included in CADENCE® DESIGN FRAMEWORK II® tool suite.

8. A method of managing software-tool access over a network, said method comprising:
associating multiple projects with a common file, defining a reference file;
associating tool information with each of said multiple projects, said tool information including a tool name and a tool version;
storing said tool information for each of said multiple projects in a common file, defining a tool file;
providing said common reference file with data indicating a location of said tool file, defining location data; and
obtaining project information from a set of data including a project name and a tool name by parsing information in said tool file, with said project information including a project name and a tool version associated with said project name.

9. The method as recited in claim 8 wherein obtaining further includes executing a search routine that obtains said location data from said reference file and locates said tool file in response to said location data.

10. The method as recited in claim 9 wherein parsing said tool information further includes parsing said tool information associated with a group of said multiple projects.

11. The method as recited in claim 10 wherein said project information includes a project name and a version of said common tool associated with said project name.

12. The method as recited in claim 11 wherein said tools are integrated circuit design tools.

13. The method as recited in claim 12 wherein said tools are integrated circuit design tools included in CADENCE® DESIGN FRAMEWORK II® tool suite.

14. A computer product having a computer readable medium that contains a program to manage software-tool access over a network, said method comprising:
computer code to associate multiple projects with a common file, defining a reference file;
computer code to associate tool information with each of said multiple projects, said tool information including a tool name and a tool version;
computer code to store said tool information for each of said multiple projects in a common file, defining a tool file;
computer code to provide said common reference file with data indicating a location of said tool file, defining location data; and
computer code to obtain project information from a set of data including a project name and a tool name, with said project information including a project name and a tool version associated with said project name.

15. The computer product as recited in claim 14 wherein computer code to obtain project information further includes computer code to execute a search routine to parse information in said tool file to extract all projects associated with a common tool.

16. The computer product as recited in claim 14 wherein said computer code to obtain project information further includes computer code to execute a search routine that obtains said location data from said reference file and locates said tool file in response to said location data to parse said tool information associated with one of said multiple projects.

17. The computer product as recited in claim 14 wherein said computer code to obtain project information further includes computer code to execute a search routine to parse information in said tool file to extract all project information associated with a common tool, with said project information including a project name and a version of said common tool associated with said project name.

18. The computer product as recited in claim 14 wherein said tools include computer code to facilitate design of integrated circuits.

19. The computer product as recited in claim 14 wherein said tools are integrated circuit design software included in CADENCE® DESIGN FRAMEWORK II® tool suite.

20. A computer system to manage software-tool access over a network, said system comprising:
a processor;
a memory in data communication with said processor, with said memory including a memory in data communication with said processor, said memory including a computer readable program to be operated on by said processor that includes a first subroutine to associate multiple projects with a common file, defining a reference file, a second subroutine to associate tool information with each of said multiple projects, said tool information including a tool name and a tool version, a third subroutine to store said tool information for each of said multiple projects in a common file, defining a tool file, a fourth subroutine to provide said common reference file with data indicating a location of said tool file, defining location data; and a fifth subroutine to obtain project information from a set of data including a project name and a tool name, with said project information including a project name and a tool version associated with said project name.

21. The system as recited in claim 20 wherein said fifth subroutine further includes computer code to execute a search routine to parse information in said tool file to extract all projects associated with a common tool.

22. The system as recited in claim 20 wherein said fifth subroutine further includes computer code to execute a search routine that obtains said location data from said reference file and locates said tool file in response to said location data to parse said tool information associated with one of said multiple projects.

23. The system as recited in claim 20 wherein said fifth subroutine further includes computer code to execute a search routine to parse information in said tool file to extract all project information associated with a common tool, with said project information including a project name and a version of said common tool associated with said project name.

24. The system as recited in claim 19 wherein said tools include software programs to facilitate design of integrated circuits.

25. The system as recited in claim 24 wherein said tools are integrated circuit design software included in CADENCE® DESIGN FRAMEWORK II® tool suite.
